(19) United States
(12) Patent Application Publication
(10) Pub. No.: US 2006/0260431 A1
(43) Pub. Date: Nov. 23, 2006

(54) Window handle

(75) Inventor: Bryan Gill, Holland Landing (CA)

Correspondence Address: PILLSBURY WINTHROP SHAW PITTMAN, LLP, P.O. BOX 10500, MCLEAN, VA, 22102, US

(73) Assignee: Armada Toolworks Ltd., Lindsay (CA)

(21) Appl. No.: 11/130,133

(22) Filed: May 17, 2005

(51) Int. Cl. G05G 1/00

(52) U.S. Cl. 74/545

(57) ABSTRACT

A window handle is configured to be manually snapped onto a driveshaft of a window actuator of a window. A locking structure securely attaches the handle to the driveshaft to prevent the handle from being pulled off of the driveshaft. The window handle is a folding handle that includes an arm that pivots relative to a base between closed and operable positions. A detent mechanism releasably holds the arm in its open position. A compression spring provides operational biasing force to both the detent mechanism and the locking structure. The arm and base include mating protrusions and bores that fit together to define a pivotal connection between the arm and the base.

### BACKGROUND OF THE INVENTION

1. Field of the Invention

This invention relates to handles for window actuators.

2. Description of Related Art

It is well known to provide a window (e.g., a casement window) with a window actuator that relies on rotation of an attached handle to open and close the window. Such window actuators and window handles are described in, for example, U.S. Pat. Nos. 5,168,770, 5,560,082, and 6,164,156.

The rotating handle projects outwardly from the window frame. To make the handle more compact when it is not being used to open or close a window, it is known to provide a folding handle that pivots toward the window. Conventional examples of such folding handles are described in the above-noted patents.

Conventional mechanisms that attach window handles to window actuators and/or conventional mechanisms that facilitate the folding of window handles are frequently complex and require numerous parts.

### SUMMARY OF THE INVENTION

Accordingly, one aspect of one or more embodiments of this invention provides a folding window handle that can easily and securely be mounted to a window actuator.

Another aspect of one or more embodiments of this invention provides a handle configured to mount to a rotatable driveshaft having a groove. An arm of the handle connects to a base. A first bore in the base is configured to receive the rotatable driveshaft. A first locking structure movably connects to the base to allow the first locking structure to move into the first bore to a locking position. The first locking structure is configured to engage the groove of the driveshaft in the locking position thereof. The first locking structure is constructed to move to the locking position and to engage the groove to lock the handle to the driveshaft in response to the bore being received over the driveshaft.

According to a further aspect of one or more of these embodiments, the handle also includes a resilient member (e.g., elastic member, compression spring, etc.) operatively engaged with the first locking structure to bias the first locking structure into the first bore to the locking position. When the driveshaft is received in the first bore, the first locking structure moves to the locking position and engages the groove to releasably lock the handle onto the driveshaft.

According to a further aspect of one or more of these embodiments, the handle is configured such that when it is mounted to the driveshaft, applying a manual force to the handle in an attempt to remove the handle from the driveshaft does not urge the first locking structure out of engagement with the groove. Alternatively, the handle may be designed such that a predetermined upwardly directed force (e.g., 5 pounds) does disengage the handle from the driveshaft.

According to a further aspect of one or more of these embodiments, a second bore is disposed in the base. The second bore connects to the first bore. The resilient member is at least partially disposed in the second bore. The first locking structure is at least partially disposed within the second bore. The second bore may extend upwardly away from the first bore at an acute angle. A stop may be disposed in the second bore to prevent the first locking structure from moving entirely out of the second bore and entirely into the first bore.

According to a further aspect of one or more of these embodiments, the arm pivotally connects to the base to allow pivotal movement relative to the base between folded and operative positions. The first locking structure is disposed between the resilient member and the first bore. The handle further includes a second locking structure disposed at least partially in the second bore on an opposite side of the resilient member from the first locking member. The handle further includes an arm pivotally connected to the base to allow pivotal movement relative to the base between folded and operative positions. The handle further includes a detent disposed on the arm. The resilient member biases the second locking structure toward the arm such that when the arm is moved into its operative position, the second locking structure engages the detent to releasably lock the arm in the operative position.

According to a further aspect of one or more of these embodiments, when the arm is in the operative position, the arm may be moved into the folded position by pushing it downwardly with sufficient force to overcome a biasing force of the resilient member and the engagement of the second locking structure with the detent, thereby disengaging the second locking structure from the detent.

According to a further aspect of one or more of these embodiments, the handle is attached to a driveshaft of a window actuator. The window actuator is operatively connected to a window to open and close the window.

Another aspect of one or more embodiments of this invention provides a handle configured to mount to a rotatable driveshaft. The handle includes a base. A first bore is disposed in the base and configured to receive the rotatable driveshaft. An arm pivotally connects to the base to allow pivotal movement relative to the base between folded and operative positions. The pivotal connection between the base and arm includes a protrusion integrally formed as a unitary piece with one of the arm and the base, and a second bore disposed on the other of the arm and the base. The second bore and the protrusion engage each other to define the pivotal connection.

Another aspect of one or more embodiments of this invention provides a handle configured to mount to a rotatable driveshaft. The handle includes a base. A first bore is disposed in the base and configured to receive the rotatable driveshaft. An arm pivotally connects to the base to allow pivotal movement relative to the base between folded and operative positions. The pivotal connection between the base and arm includes a protrusion disposed on one of the arm and the base, and a second bore disposed on the other of the arm and the base. The protrusion has an axis that intersects the first bore. The second bore and the protrusion engage each other to define the pivotal connection. The protrusion may be integrally formed with the one of the arm and the base.

Another aspect of one or more embodiments of this invention provides a method of manufacturing a handle for a window actuator. The method includes providing an arm and a base constructed to be connected to the driveshaft of the window actuator. The method also includes providing a fixed protrusion on one of the arm and the base, and then engaging the protrusion with a second bore in the other of the arm and the base to define a pivotal connection between the arm and the base such that the arm is pivotal relative to the base between folded and operative positions. Providing the fixed protrusion may include integrally forming the protrusion with the one of the arm and the base. Providing the fixed protrusion may alternatively include rigidly connecting the protrusion to the one of the arm and the base after the base is formed. Engaging the protrusion with the second bore may include using a groove disposed in the other of the arm and the base to guide the protrusion toward the second bore during assembly of the handle. The groove intersects the second bore.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a cross-sectional view of a window handle according to an embodiment of the present invention, with the handle in a folded position;

FIG. 2 is a cross-sectional view of the window handle of FIG. 1, with the handle in an open/operative position;

FIG. 3 is a bottom perspective view of the window handle of FIG. 1;

FIG. 4 is a cross-sectional view of a base of the window handle of FIG. 1; and

FIG. 5 is a perspective view of a window incorporating the window handle of FIG. 1.

### DETAILED DESCRIPTION OF PREFERRED EMBODIMENTS

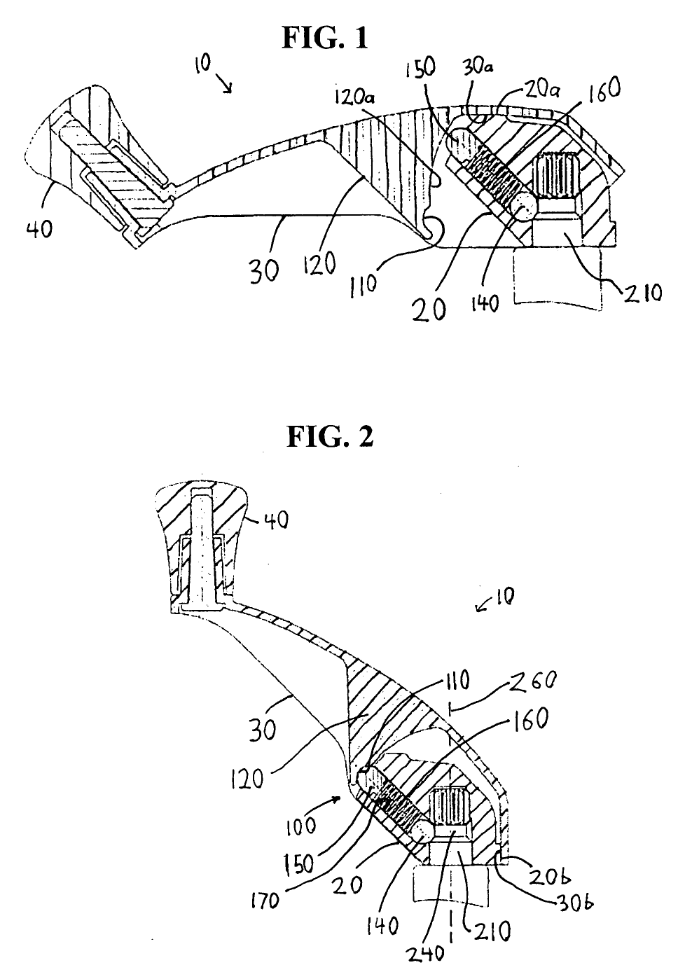

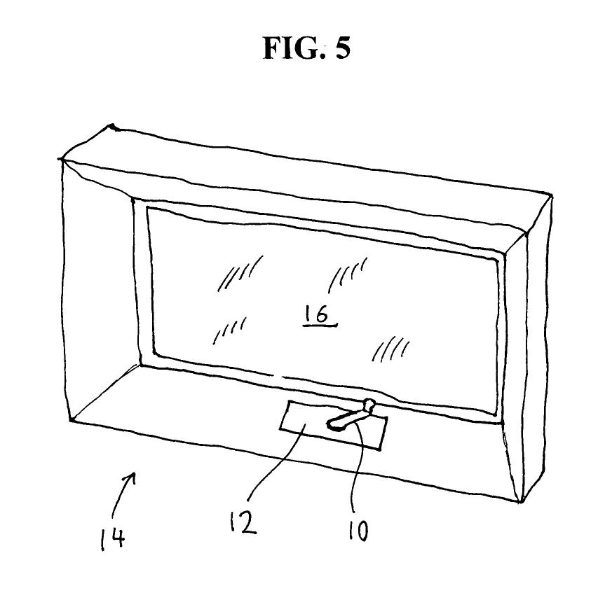

FIGS. 1-5 illustrate a window assembly 14 with a window handle 10 according to an embodiment of the present invention. As shown in FIG. 5, the window handle 10 mounts to a window actuator 12 of the window assembly 14. Selective rotation of the window handle 10 rotates a driveshaft 210 (FIG. 1) of the window actuator 12, which, in turn, opens or closes a window 16 of the window assembly 14. The window actuator 12 may comprise any suitable window actuator, as would be understood by those of ordinary skill in the art.

As shown in FIG. 1, the window handle 10 includes a base 20, an arm 30, and a knob 40. For convenience, directions (e.g., up, down, etc.) are defined relative to the views illustrated in FIGS. 1 and 2. However, depending on how the handle 10 is mounted to a particular window actuator 12 and window 14, the upper part of the handle 10 as viewed in FIGS. 1 and 2 may extend horizontally (e.g., if the handle is mounted to a vertical surface of a window frame).

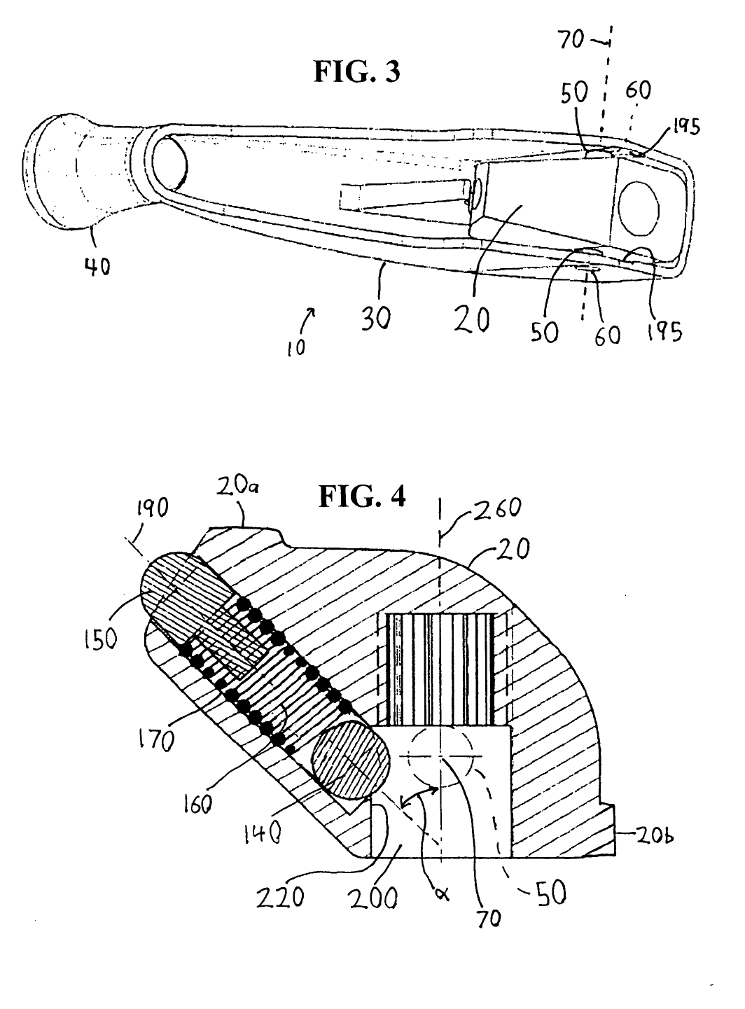

Hereinafter, a pivotal connection between the base 20 and the arm 30 is described with reference to FIGS. 1-3. As shown in FIG. 3, the base 20 includes two laterally extending protrusions (e.g., cylindrical pins, spigots) 50 that mate with two corresponding bores 60 in the arm 30 to define an arm pivot axis 70. The protrusions 50 are integrally formed with the base 20 (e.g., via integral molding, casting, etc.) to reduce the number of discrete components in the handle 10, but may alternatively be attached to the base 20 after formation (e.g., via welding, glue, threaded joint, bolts, etc.) without deviating from the scope of the present invention. The protrusions 50 are preferably connected to the base 20 before the base 20 is connected to the arm 30. The bores 60 may be through-bores, blind bores, or any other type of suitable bore.

As shown in FIG. 3, grooves 195 are formed in the inside of the arm 30 to guide the protrusions 50 toward and into the bores 60 during assembly of the handle 10.

As shown in FIG. 4, the axis 70 intersects a bore 200 in the base 20. The protrusions 50 are preferably disposed laterally outwardly from the bore 200 so that the protrusions 50 do not interfere with or occupy any space within the bore 200. Alternatively, the axis 70 could be offset from the bore 200 without deviating from the scope of the present invention.

In the illustrated embodiment, the protrusions 50 are connected to the base 20 and the bores 60 are formed in the arms 30. Alternatively, the protrusions 50 could be connected to the arm 30 and the bores 60 could be disposed on the base 20 without deviating from the scope of the present invention.

While the illustrated pivotal connection utilizes protrusions 50 and bores 60, any other suitable pivotal joint may alternatively be used without deviating from the scope of the present invention. The pivotal connection enables the arm 30 to pivot relative to the base 20 between a down/folded/stowed position (FIG. 1) and an up/open/operative position (FIG. 2).

While the illustrated arm 30 pivotally attaches to the base 20, the arm 30 and base 20 may alternatively rigidly connect to each other (e.g., via integral formation, integral molding, integral casting, bolts, glue, fasteners, etc.) without deviating from the scope of the present invention.

As shown in FIG. 1, positive stop portions 20a, 30a of the base 20 and arm 30 abut each other when the arm 30 is in the folded position to limit the downward pivotal movement of the arm 30. Similarly, as shown in FIG. 2, positive stop portions 20b, 30b of the base 20 and arm 30 abut each other when the arm 30 is in the operative position to limit the upward pivotal movement of the arm 30.

As shown in FIG. 2, a detent mechanism 100 retains the arm 30 in the operative position when the arm 30 is moved into the operative position. The detent mechanism 100 includes a single detent 110 disposed on the arm 30. In the illustrated embodiment, the detent 110 is a groove 110 formed in an internally protruding flange 120 of the arm 30. The detent 110 and flange 120 are preferably integrally formed with the arm 30, but may alternatively be attached to or formed in the arm 30 after formation.

As shown in FIG. 4, two locking structures 140, 150 are disposed at opposite ends of a compression spring 160 (or other resilient member) within a bore 170 in the base 20. Accordingly, the structures 140, 150 can move axially within the bore 170. The spring 160 biases the locking structure 150 upwardly toward a distal end of the base 20. The structure 150 has a convex surface that mates with a complementary concave surface of the detent 110 such that the biasing force of the spring 160 and structure 150 tends to keep the arm 30 in the operative position once the arm 30 is moved into the operative position. To move the opened arm 30 into its folded position, the arm 30 is manually pushed downward so that the downward force along the sloped intersection between the structure 150 and detent 110 overcomes the biasing force of the spring 160, thereby disengaging the structure 150 from the detent 110 and allowing the arm 30 to pivot into its folded position (FIG. 1).

While the illustrated structures 140, 150 move axially within a bore, the structures 140 and/or 150 could alternatively movably connect to the base 20 in any other suitable way (e.g., via a connection to a pivot arm that is pivotally connected to the base).

While the illustrated detent 110 and structure 150 include complimentary convex and concave surfaces, any other suitable complimentary surface shape may alternatively be used without deviating from the scope of the present invention.

In the illustrated embodiment, the structure 140 comprises a ball (e.g. metal ball bearings) while the structure 150 comprises a mushroom shaped plunger. However, the structures 140, 150 could comprise balls, plungers, pins, or other suitable structures without deviating from the scope of the present invention. Indeed, the structures 140, 150 may have any shape or configuration, and are not limited to the ones depicted.

As shown in FIG. 1, when the arm 30 is in the folded position, the structure 150 does not lock the arm 30 in position. As the arm 30 is moved into the open position, the structure 150 slidingly abuts a sloped surface 120a on the flange 120, which pushes the structure 150 inwardly and compresses the spring 160 until the structure 150 can engage the detent 110.

While the illustrated arm 30 includes a single detent 110 for pivotally locking the arm 30 relative to the base 20 in a single detent position (the operative position), additional detent(s) could be added to provide additional locking positions (e.g., locked folded position) for the arm 30 without deviating from the scope of the present invention.

Hereinafter, the attachment of the handle 10 to the window actuator 12 is described with reference to FIGS. 2 and 4. As shown in FIG. 4, the base 20 includes a splined bore 200 that mates with internal splines of a driveshaft 210 (FIG. 2) of the window actuator 12 of a window 14 (FIG. 5) to prevent the handle 10 from rotating relative to the driveshaft 210 about an axis 260. While the bore 200 and driveshaft 210 include complimentary splines, any other complimentary surface features or mechanisms (e.g., pinned connection) could alternatively be used to prevent relative rotational movement of the bore 200 and driveshaft 210 without deviating from the scope of the present invention. While the illustrated bore 200 has a circular cross-section, the bore 200 and driveshaft 210 could alternatively have other cross-sectional shapes (e.g., square, hexagonal, polygonal, irregular) without deviating from the scope of the present invention. The splines may be omitted without deviating from the scope of the present invention.

As shown in FIG. 4, a positive stop 220 on the base 20 allows the structure 140 to extend partially, but not entirely, into the bore 200. To attach the handle 10 to the driveshaft 210, the driveshaft 210 is press fit into the bore 200. An upper end of the driveshaft 210 deflects the structure 140 upwardly and away from the driveshaft 210 against the biasing force of the spring 160 until the structure 140 aligns with an annular groove 240 in the driveshaft 210 (see FIG. 2). The spring 160 then urges the structure 140 into the groove 240 and locks the handle 10 onto the driveshaft 210. Accordingly, the handle 10 may be easily and securely manually snapped onto the driveshaft 210 without the use of tools (e.g., screwdrivers, hex wrenches, etc.).

As shown in FIG. 4, the bore 170 extends upwardly away from the bore 200 at an acute angle α formed between an axis 190 of the bore 170 and the axis 260 of the bore 200. The angle α is preferably less than 85 degrees, is more preferably less than 70 degrees, and is more preferably about 45 degrees. However, the angle α may alternatively be any other suitable angle (e.g., a right angle or an obtuse angle) without deviating from the scope of the present invention. The acuteness of the angle α makes it easier for the driveshaft 210 to deflect the structure 140 away from the bore 200 when the handle 10 is attached to the driveshaft 210.

Once the handle 10 is mounted to the driveshaft 210, the acuteness of the angle α may prevent upwardly directed force on the handle 10 from moving the structure 140 upwardly and releasing the handle 10 from the driveshaft 210. In particular, a resulting line of force applied to the structure 140 (in a direction perpendicular to a line of contact between the driveshaft 210 and the structure 140) is either perpendicular to the axis 190 of the bore 170 or is directed toward a proximal end of the bore 170. This line of force is determined by the relative shapes and orientations of the mating surfaces of the structure 140 and driveshaft 210. This can be referred to as a binding action, as the structure 140 binds against the bore 170 wall as the user attempts to lift the handle 10.

To detach the handle 10 from the driveshaft 210, a tool may be required to deflect the structure 140 distally within the bore 170 before the driveshaft 210 can be taken out of the bore 200. For example, a slot that aligns with and extends into the bore 170 may be formed in the base 20 to allow a small tool to be extended into the slot and bore 170 below the structure 140 and moved upwardly to separate the structure 140 from the groove 240 in the driveshaft 210. Alternatively, detachment of the handle 10 from the driveshaft 210 may require detachment of the arm 30 from the base 20 to allow the structures 140, 150 and spring 160 to be moved upwardly out of the bore 170 and away from the driveshaft 210.

Alternatively, the handle 10 may be designed such that applying sufficient upward force to the handle 10 separates it from the driveshaft 210. For example, the angle α may be sufficiently large (e.g., a large acute angle, or an angle that is at or near 90 degrees, etc.) that upwardly directed force on the handle 10 moves the structure 140 out of engagement with the driveshaft 210. Alternatively or additionally, the mating surfaces of the structure 140 and driveshaft 210 may be shaped and configured such that upwardly directed force on the handle 10 moves the structure 140 out of engagement with the driveshaft 210 (e.g., a line of force between the driveshaft 210 and the structure 140 is directed toward a distal end of the bore 170). In such an embodiment, the handle 10 may be detached by wedging a tool (e.g., a flat screwdriver) between the handle 10 and a housing of the window actuator 12 (see FIG. 5) to pry the handle 10 off. Applying significant upward manual force without a tool (e.g., over 2 pounds of force, over 5 pounds of force, over 10 pounds of force, etc.) to the handle 10 may also be sufficient to detach it from the driveshaft 210.

Use of the spring 160 to bias both the structure 140 and the structure 150 reduces the number of components in the handle 10 by eliminating the need for multiple springs. It also preferably simplifies assembly of the handle 10. While the illustrated spring 160 is a single spring, the spring 160 may alternatively comprise multiple springs lined up in series within the bore 170. To assemble the handle 10, the structure 140, spring 160, and structure 150 are sequentially fit into the bore 170 through its upper/distal opening. The arm 30 is then fit onto the base 20 to mate the protrusions 50 with the bores 60. The arm 30 and/or the base 20 preferably comprise an elastically deformable material(s) that allow the protrusions 50 to fit between lateral sides of the arm 30 before the protrusions 50 and bores 60 align and engage each other. Alternatively, the arm 30 may comprise a plastically deformable material (e.g., a die cast metal part) that is cast wide (e.g., with the walls of the arm 30 expanded laterally outwardly from each other), fit over the base 20, and then plastically deformed into a closed shape in which the protrusions 50 and bores 60 align and engage each other.

As shown in FIG. 2, the knob 40 pivotally connects to the arm 30 for rotation relative to the arm 30 about an axis that is generally parallel to the axis 260 of the bore 200 and driveshaft 210 when the arm 30 is in the operative position.

While the illustrated handle 10 is used in connection with the window actuator 12 of the window 14, the handle 10 could alternatively be used in conjunction with any other device in which such a rotatable, folding handle would be desirable. For example, the handle 10 could be used to operate an automobile window or as a tightening device for a bolt attached to the handle 10 in place of a driveshaft. Alternatively, the handle 10 could be connected to any other manually rotated driveshaft.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A handle configured to mount to a rotatable driveshaft having a groove, the handle comprising:
an arm;
a base connected to the arm;
a first bore in the base configured to receive the rotatable driveshaft; and
a first locking structure movably connected to the base to allow the first locking structure to move into the first bore to a locking position, the first locking structure being configured to engage the groove of the driveshaft in the locking position thereof,
wherein the first locking structure is constructed to move to the locking position and to engage the groove to lock the handle to the driveshaft in response to the bore being received over the driveshaft.

2. The handle of claim 1, further comprising a resilient member operatively engaged with the first locking structure to bias the first locking structure into the first bore to the locking position such that, when the driveshaft is received in the first bore, the first locking structure moves to the locking position and engages the groove to releasably lock the handle onto the driveshaft.

3. The handle of claim 2, wherein the handle is configured such that when it is mounted to the driveshaft, applying a manual force to the handle in an attempt to remove the handle from the driveshaft does not urge the first locking structure out of engagement with the groove.

4. The handle of claim 2, wherein the handle is configured such that when it is mounted to the driveshaft, a separating force of at least 5 pounds must be applied to the handle to move the first locking structure out of engagement with the groove and remove the handle from the driveshaft.

5. The handle of claim 2, wherein the handle is configured such that when it is mounted to the driveshaft, the handle does not become disengaged under normal operation, but can be removed by applying a predetermined manual force to the handle so as to move the first locking structure out of engagement with the groove.

6. The handle of claim 2, further comprising a second bore in the base, the second bore connecting to the first bore, wherein the resilient member is at least partially disposed in the second bore, wherein the first locking structure is at least partially disposed within the second bore.

7. The handle of claim 6, wherein the first bore includes a surface feature that is configured to mate with a complimentary surface feature of the driveshaft to prevent the handle from rotating relative to the driveshaft about a driveshaft axis when the handle is mounted to the driveshaft.

8. The handle of claim 6, wherein the second bore extends upwardly away from the first bore at an acute angle.

9. The handle of claim 6, further comprising a stop disposed in the second bore, the stop preventing the first locking structure from moving entirely out of the second bore and entirely into the first bore.

10. The handle of claim 6, wherein the arm pivotally connects to the base to allow pivotal movement relative to the base between folded and operative positions, wherein the first locking structure is disposed between the resilient member and the first bore, and wherein the handle further comprises:
a second locking structure disposed at least partially in the second bore on an opposite side of the resilient member from the first locking member; and
a detent disposed on the arm,
wherein the resilient member biases the second locking structure toward the arm such that when the arm is moved into its operative position, the second locking structure engages the detent to releasably lock the arm in the operative position.

11. The handle of claim 10, wherein, when the arm is in the operative position, the arm may be moved into the folded position by pushing it downwardly with sufficient force to overcome a biasing force of the resilient member and the engagement of the second locking structure with the detent, thereby disengaging the second locking structure from the detent.

12. The handle of claim 10, wherein the resilient member comprises a compression spring.

13. The handle of claim 1, in combination with a window assembly comprising:
a window; and
a window actuator operatively connected to the window to open and close the window,
wherein the window actuator includes the driveshaft.

14. A handle configured to mount to a rotatable driveshaft, the handle comprising:
a base;
a first bore in the base configured to receive the rotatable driveshaft; and
an arm pivotally connected to the base to allow pivotal movement relative to the base between folded and operative positions,
wherein the pivotal connection between the base and arm comprises
a protrusion integrally formed as a unitary piece with one of the arm and the base, and
a second bore disposed on the other of the arm and the base,
wherein the second bore and the protrusion engage each other to define the pivotal connection.

15. A handle configured to mount to a rotatable driveshaft, the handle comprising:
a base;
a first bore in the base configured to receive the rotatable driveshaft; and
an arm pivotally connected to the base to allow pivotal movement relative to the base between folded and operative positions,
wherein the pivotal connection between the base and arm comprises
a protrusion disposed on one of the arm and the base, the protrusion having an axis that intersects the first bore, and
a second bore disposed on the other of the arm and the base,
wherein the second bore and the protrusion engage each other to define the pivotal connection.

16. The handle of claim 15, wherein the protrusion is integrally formed with the one of the arm and the base.

17. A method of manufacturing a handle for a window actuator, the method comprising:
providing an arm;
providing a base constructed to be connected to the driveshaft of the window actuator;
providing a fixed protrusion on one of the arm and the base; and
then engaging the protrusion with a second bore in the other of the arm and the base to define a pivotal connection between the arm and the base such that the arm is pivotal relative to the base between folded and operative positions.

18. The method of claim 17, wherein providing the fixed protrusion comprises integrally forming the protrusion with the one of the arm and the base.

19. The method of claim 17, wherein providing the fixed protrusion comprises rigidly connecting the protrusion to the one of the arm and the base after the base is formed.

20. The method of claim 17, wherein engaging the protrusion with the second bore comprises using a groove disposed in the other of the arm and the base to guide the protrusion toward the second bore during assembly of the handle, wherein the groove intersects the second bore.
